(19) United States
(12) Patent Application Publication
(10) Pub. No.: US 2008/0024251 A1
(43) Pub. Date: Jan. 31, 2008

(54) COAXIAL WAVEGUIDE CONVERTER CIRCUIT FOR TRAVELING-WAVE TUBE, METHOD OF MANUFACTURING SAME, AND WAVEGUIDE MATCHING PART FOR USE IN COAXIAL WAVEGUIDE CONVERTER CIRCUIT

(75) Inventors: Kazuhito SOGA, Sagamihara-shi (JP); Akihiko Nemoto, Sagamihara-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC MICROWAVE TUBE, LTD., Sagamihara-shi (JP)

(21) Appl. No.: 11/779,772

(22) Filed: Jul. 18, 2007

(30) Foreign Application Priority Data
Jul. 25, 2006 (JP) 2006-201882

(51) Int. Cl. H01P 3/06

(52) U.S. Cl. 333/243

(57) ABSTRACT

A coaxial waveguide converter circuit is provided for converting an input/output coaxial section of a traveling-wave tube to a waveguide. The circuit comprises a waveguide matching part for connecting an inner conductor of the coaxial section extending into the waveguide to a wall of the waveguide. The waveguide matching part includes a fitting hole for fitting the inner conductor thereinto, and a plurality of cantilever supports which define the fitting hole at leading end portions thereof. The leading end portions of the plurality of cantilever supports defining the fitting hole are uniformly kept in close contact with a peripheral surface of the inner conductor.

This application is based upon and claims the benefit of priority from Japanese patent application No. 2006-201882, filed on Jul. 25, 2006, the disclosure of which is incorporated herein in its entirety by reference.

### BACKGROUND OF THE INVENTION

1. Field of the Invention

The present invention relates to an input/output section of a traveling-wave tube for amplifying microwaves. In particular, the present invention relates to the structure of a coaxial waveguide converter circuit for converting the mode of the microwave when a microwave is applied from a waveguide to an input coaxial section of a traveling-wave tube, or for converting the mode of the microwave when a microwave is delivered from an output coaxial section of the traveling-wave tube to the waveguide.

2. Description of the Related Art

FIG. 1 is a longitudinal sectional view schematically illustrating the configuration of a general traveling-wave tube disclosed in Japanese laid-open patent publication No. 2005-339892A. Traveling-wave tube 100 generally comprises electron gun 101, delay circuit 102, and collector 103. Delay circuit 102 comprises helix 105 securely supported by dielectric 106 within vacuum sheath 104. Delay circuit 102 comprises, at both ends thereof, input circuit 107 for applying a microwave to helix 105 within traveling-wave tube 100, and output circuit 108 for delivering a microwave which is amplified while it propagates through helix 105, respectively. When waveguides 109 are used in input circuit 107 and output circuit 108, a coaxial waveguide converter circuit is formed between waveguides 109 and input/output coaxial sections 110 of traveling-wave guide 100 for converting the mode of the microwave.

A structure as shown in Japanese utility model publication No. H02-32208 has been proposed for the coaxial waveguide converter circuit. As illustrated in FIG. 2, this structure comprises cylindrical coaxial outer conductor 203 which couples waveguide 201 with outer sheath 202 of a traveling-wave tube, and coaxial inner conductor 205 which extends within waveguide 201 along the center axis of coaxial outer conductor 203 from outer sheath 202 of the traveling-wave tube to connect helix 204 to waveguide 201. Further, a gap between coaxial outer conductor 203 and coaxial inner conductor 205 is sealed by ceramic window 206 under vacuum. In addition, waveguide matching part 207 is used at the joint of coaxial inner conductor 205 and waveguide wall 201a for impedance matching of a coaxial section comprised of coaxial outer conductor 203 and coaxial inner conductor 205 with waveguide 201.

Waveguide matching part 207, which comprises a cylindrical member, is fitted into a hole formed through waveguide wall 201a from the outside of waveguide tube 201 for fixation therein, and cylindrical coaxial inner conductor 205 is fitted into waveguide matching part 207. A cylindrical hole of part 207 has its leading end portion narrower than the remaining portion, such that coaxial inner waveguide 205 is fitted into a narrow hole (hereinafter called “fitting hole 207a”) at the leading end of part 207. Also, part 207 is made of a resilient material (for example, phosphor bronze), and is formed with a plurality of slits 207b from the leading end thereof, as illustrated in FIGS. 3A and 3B.

Before such waveguide matching part 207 is fitted into waveguide 201 from the outside thereof, cantilever supports 207c, divided by slits 207b, are previously urged toward the center axis (in other words, fitting hole 207a is narrowed). By fitting coaxial inner conductor 205 into waveguide matching part 207 in this state, waveguide matching part 207 is brought into contact with coaxial inner conductor 205. The contact between waveguide matching part 207 and coaxial inner conductor 205 is maintained by the resiliency of cantilever support 207c.

According to the structure of the above waveguide matching part 207, part 207 can be brought into contact with coaxial inner conductor 205 without requiring a high machining accuracy for part 207, and is also assembled into waveguide 201 with ease.

However, the waveguide matching part of the coaxial waveguide converter circuit as disclosed in Japanese utility model publication No. H02-32208 is configured to make a contact with the coaxial inner conductor by urging the cantilever support to narrow the coaxial inner conductor fitting hole. As such, when relying on manual operations, the fitting hole is non-uniformly narrowed, resulting in a non-circular fitting hole which is brought into contact with the cylindrical coaxial inner conductor. Consequently, the contact is exacerbated between the coaxial inner conductor and waveguide matching part. On the other hand, when the operation is automated to uniformly narrow the fitting hole, the manufacturing cost is increased.

On the other hand, the coaxial inner conductor fitting hole in the conventional waveguide matching part is a straight hole which has a diameter larger than that of the coaxial inner conductor. Specifically, as illustrated in FIG. 4(a), wall surfaces of cantilever supports 207c which define fitting hole 207a are substantially parallel with the center line of fitting hole 207a. Accordingly, when waveguide matching part 207 is brought into contact with coaxial inner conductor 205, with cantilever supports 207c being previously urged, the wall surfaces of cantilever supports 207c which define fitting hole 207a are inclined, causing fitting hole 207a to come into point contact with coaxial inner conductor 205, as illustrated in FIG. 4(b). This further engraves the problem of the contact when the fitting hole is manually narrowed.

As described above, when the coaxial inner conductor is insufficiently in contact with the waveguide matching part, a problem arises in which the heat dissipation capability from the coaxial inner conductor is reduced.

Specifically, in a traveling-wave tube, as an electron beam passes through the delay circuit, the electron beam impinges on the inner wall of the helix to generate heat. Heat is also generated due to a high frequency loss when a microwave passes through the helix. Such heat generated in the helix is dissipated from the outer sheath of the traveling-wave tube, and is also dissipated from the waveguide through the coaxial inner conductor and waveguide matching part connected to the helix, and the like.

However, when the heat dissipation capability from the coaxial inner conductor is reduced, this causes the temperature to rise in the coaxial section and helix, which results in degraded electric characteristics and instable operations. In the worst case, discharge, sputtering and the like have occasionally occurred in the coaxial section to render the traveling-wave guide defective in operation.

Also, since the temperature rises during the operation of the traveling-wave guide, the contact exacerbates between the coaxial inner conductor and waveguide matching part due to a difference in thermal expansion between respective parts which make up the coaxial waveguide converter circuit, possibly resulting in a further degradation of the heat dissipation effect from the coaxial inner conductor.

### SUMMARY OF THE INVENTION

In view of the problems of the related art mentioned above, it is an exemplary object of the present invention to improve contact between a coaxial inner conductor and a waveguide matching part to enhance heat dissipation capabilities over the conventional structure.

A coaxial waveguide converter circuit according to an exemplary of the present invention comprises a waveguide matching part for connecting the inner conductor of a coaxial section extending into a waveguide to a wall of the waveguide. This part comprises a fitting hole into which the inner conductor is fitted, and a plurality of resilient cantilever supports, the leading end portions of which define the fitting hole. To solve the problems mentioned above, the inner conductor is tapered only in its leading end portion, and an opening of the fitting hole, into which the inner conductor is inserted, has a diameter larger than the diameter of the inner conductor at the extreme leading end thereof, and smaller than the outer diameter of the body of the inner conductor except for the leading end portion. Thus, when the inner conductor is inserted into the fitting hole of the waveguide matching part, each cantilever support uniformly displaces outward in the radial direction of the waveguide matching part in conformity to the outer diameter of the inner conductor, and simultaneously, each cantilever support is kept in good contact with the inner conductor with the aid of resiliency of the cantilever supports.

According to the foregoing configuration, the heat conduction property is improved over the related art when heat is dissipated from the inner conductor to the waveguide through the waveguide matching part. Consequently, the waveguide matching part improves the effect of preventing the temperature from rising in the coaxial section and helix, thus allowing stable operation without causing degraded electric characteristics. In addition, the inner conductor is readily fitted into the waveguide matching part.

Further, the fitting hole of the waveguide matching part that is used is preferably tapered with its diameter being increasingly reduced toward the opening of the fitting hole into which the inner conductor is inserted, and the insertion opening has a diameter smaller than the outer diameter of the inner conductor. In the thus shaped part, the fitting hole includes an opening opposite to the inner conductor insertion opening. The opening is formed with the same diameter as the outer diameter of the inner conductor, thereby allowing each cantilever support to come into plane contact with the inner conductor, when the inner conductor is fitted into the fitting hole. In other words, the heat dissipation capability is further improved.

Also, to solve the problems mentioned above, in the structure according to the other exemplary aspect of the present invention, the waveguide may include a hole formed through its wall for fitting thereinto a portion of the waveguide matching part comprised of the plurality of cantilever supports to fix the portion therein, where the hole is tapered with its diameter being increasingly reduced from the outside to the inside of the waveguide. A waveguide matching part for use in this structure comprises a fitting hole for fitting the inner conductor thereinto, and a plurality of resilient cantilever supports, the leading ends of which define the fitting hole. When the waveguide matching part is inserted into the tapered hole formed through the waveguide wall, each cantilever support displaces inward in the radial direction of the waveguide matching part in conformity with the increasingly reduced diameter of the tapered hole to firmly come into close contact with the inner conductor. Accordingly, this structure can also be expected to improve the heat dissipation capability over the related art.

The above and other objects, features and advantages of the present invention will become apparent from the following description with reference to the accompanying drawings which illustrate examples of the present invention.

### BRIEF DESCRIPTION OF THE DRAWINGS

FIG. 1 is a longitudinal sectional view schematically illustrating the configuration of a general traveling-wave tube;

FIG. 2 is a longitudinal sectional view schematically illustrating the configuration of a conventional coaxial waveguide converter circuit for use in a traveling-wave tube;

FIG. 3A is a front view illustrating a waveguide matching part shown in FIG. 2, when not assembled;

FIG. 3B is a plan view illustrating only the waveguide matching part shown in FIG. 2, when not assembled, viewed from the leading end side (near the traveling-wave guide);

FIG. 4 is a diagram for describing how the waveguide matching part is brought into contact with a coaxial inner conductor, both shown in FIG. 2;

FIG. 5 is a longitudinal sectional view schematically illustrating the configuration of a coaxial waveguide converter circuit for a traveling-wave tube according to a first exemplary embodiment of the present invention;

FIG. 6 is a longitudinal sectional view illustrating how a coaxial inner conductor is fitted into a simple waveguide matching part used in the first exemplary embodiment of the present invention;

FIG. 7 is a longitudinal sectional view schematically illustrating the configuration of a coaxial waveguide converter circuit for a traveling-wave tube according to a second exemplary embodiment of the present invention; and

FIG. 8 is a longitudinal sectional view illustrating how a coaxial inner conductor is connected to a waveguide through a waveguide matching part in the second exemplary embodiment of the present invention.

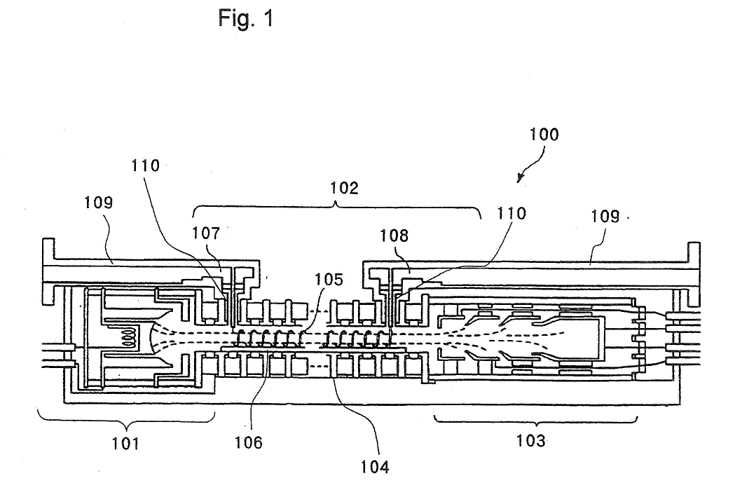

### DETAILED DESCRIPTION OF THE EXEMPLARY EMBODIMENTS

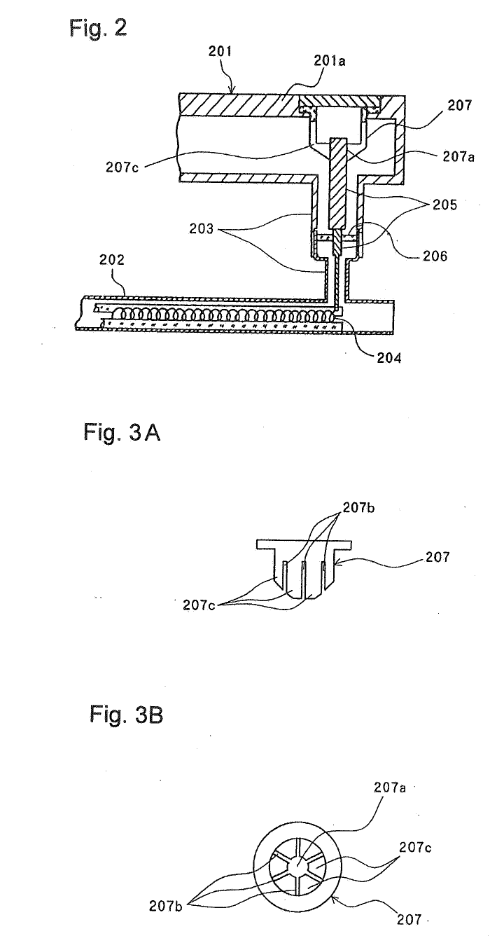

In the following description, the same reference numerals are used to designate the same components as those in the conventional coaxial waveguide converter circuit illustrated in FIG. 2.

### First Exemplary Embodiment

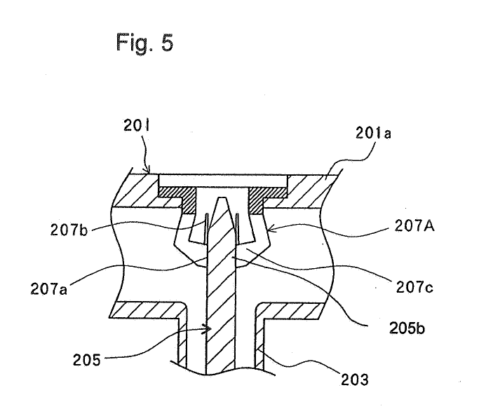

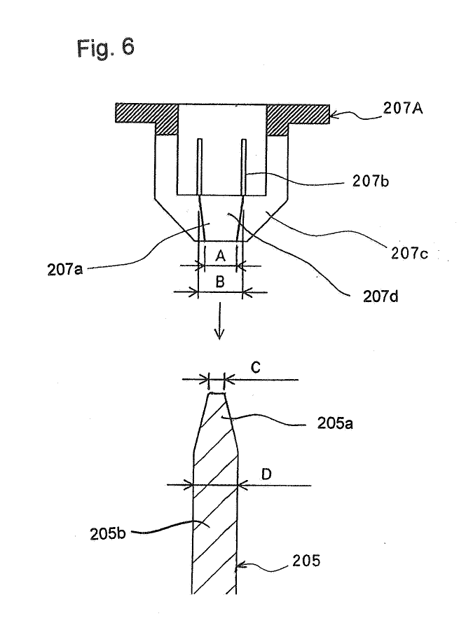

A first exemplary embodiment of the present invention will be described with reference to FIGS. 5 and 6. Both FIGS. 5 and 6 illustrate waveguide matching part 207A on a plane taken along a slit.

In FIGS. 5 and 6, a cylindrical conductor is used for coaxial inner conductor 205. Waveguide matching part 207A of this exemplary embodiment, into which coaxial inner conductor 205 is fitted, is configured in a similar manner to that illustrated in FIGS. 3A and 3B. Specifically, waveguide matching part 207A comprises a cylindrical member which has a cylindrical hole that is narrower only in a leading end portion 207d of part 207A than in the remaining portion, to define fitting hole 207a. In addition, this part 207A is made of a resilient material (for example, phosphor bronze), and is formed with a plurality of slits 207b from the leading end thereof. In this way, aided by their resiliency, cantilever supports 207c, that are divided by respective slits 207b, can displace towards the center axis of fitting hole 207a. As illustrated in FIG. 5, when coaxial inner conductor 205 is fitted into fitting hole 207a of waveguide matching part 207A, each cantilever support 207c aided by its resiliency is in contact with coaxial inner conductor 205. It should be noted that a plurality of cantilever supports 207c of waveguide matching part 207A protrude into the inside of waveguide wall 201a, and no waveguide wall 201a exists around cantilever supports 207c (outside of waveguide matching part 207A in the radial direction).

In particular, in this exemplary embodiment, coaxial inner conductor fitting hole 207a of waveguide matching part 207A, when coaxial inner conductor 205 is not fitted thereinto, has a tapered circular shape, the diameter of which is gradually reduced toward the leading end 207d of part 207A (opening into which coaxial inner conductor 205 is inserted), as illustrated in FIG. 6. Further, leading end portion 205a of cylindrical coaxial inner conductor 205, which extends into the waveguide, is tapered with its diameter gradually reduced toward the leading end, or leading end portion 205a has its edge chamfered.

Further, as illustrated in FIG. 6, at the leading end 207d of waveguide matching part 207A, diameter A of the opening in tapered fitting hole 207a is smaller than diameter B of an opening in fitting hole 207a at the rear end of waveguide matching part 207A. On the other hand, coaxial inner conductor 205 has diameter C at the leading end thereof, which is smaller than diameter D of body 205b of coaxial inner conductor 205, and which is also smaller than diameter A of the opening of fitting hole 207a. In addition, diameter D of body 205b of coaxial inner conductor 205 is larger than diameter B of the opening of fitting hole 207a, and is preferably substantially the same as diameter B of the opening of fitting hole 207a. Stated another way, a relationship D>B>A>D, preferably, D≈B>A>C is established.

As described above, since fitting hole 207a at the leading end 207d of waveguide matching part 207A has the opening, the diameter A of which is larger than diameter C at the leading end of coaxial inner conductor 205, and smaller than diameter D of body 205b of coaxial inner conductor 205, coaxial inner conductor 205 is readily inserted into fitting hole 207a of waveguide matching part 207A. Then, while coaxial inner conductor 205 is being inserted into fitting hole 207a, each cantilever support 207c deforms in conformity to the outer diameter of coaxial inner conductor 205. Consequently, a good contact can be maintained between waveguide matching part 207A and coaxial inner conductor 205. Specifically, since each cantilever support 207c uniformly extends outward in the radial direction of waveguide matching part 207A in conformity to the outer diameter of coaxial inner conductor 205 while coaxial inner conductor 205 is inserted into fitting hole 207a, the resiliency of cantilever supports 207c can serve to maintain a good contact with coaxial inner conductor 205.

In particular, when diameter D of body 205b of coaxial inner conductor 205 is substantially the same as diameter B of the opening of fitting hole 207a at the rear end of waveguide matching part 207A, wall surfaces of cantilever supports 207c which define fitting hole 207a are in contact with the peripheral surface of the body 205b of coaxial inner conductor 205, as illustrated in FIG. 5. Stated another way, in this event, they are in plane contact with each other to have a larger contact area which further improves the heat conduction property.

As described above, waveguide matching part 207A can maintain good contact with coaxial inner conductor 205 by simply inserting coaxial inner conductor 205 into fitting hole 207a, without the need for a step of previously bending cantilever supports 207c, as compared with the conventional counterpart. As a result, the heat conduction property is improved over the related art when heat generated in the helix of the traveling-wave tube is dissipated from coaxial inner conductor 205 to waveguide 201 through waveguide matching part 207A. In addition, waveguide matching part 207A improves the effect of preventing the temperature from rising in the coaxial section and helix, thus allowing stable operation without causing degraded electric characteristics.

### Second Exemplary Embodiment

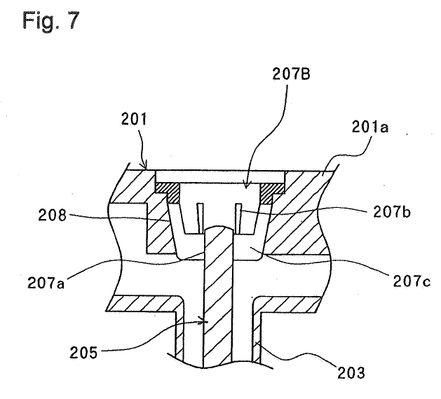

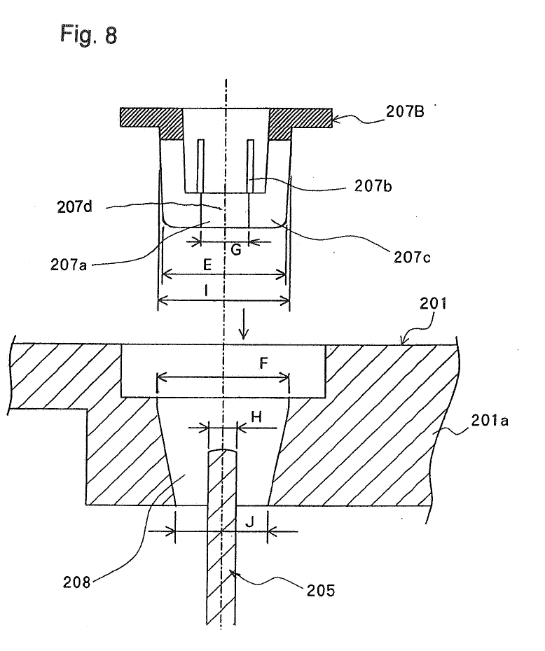

Next, a second exemplary embodiment of the present invention will be described with reference to FIGS. 7 and 8. Both FIGS. 7 and 8 illustrate waveguide matching part 207B on a plane taken along a slit.

Likewise, this exemplary embodiment employs cylindrical coaxial inner conductor 205. Waveguide matching part 207B is also configured in the same manner as that illustrated in FIGS. 3A and 3B. Specifically, waveguide matching part 207B comprises a cylindrical member which has a cylindrical hole that is narrower only at a leading end portion 207d of part 207B in than the remaining portion, to define fitting hole 207a. In addition, this part 207B is made of a resilient material (for example, phosphor bronze), and is formed with a plurality of slits 207b from the reading end of part 207B. In this way, aided by their resiliency, cantilever supports 207c, that are divided by respective slits 207b, can displace towards the center axis of fitting hole 207a. It should be noted that slits 207b have a width large enough such that the leading end of each cantilever support 207c can largely displace toward the center axis of fitting hole 207a simultaneously with the other cantilever supports 207c.

In particular, in this exemplary embodiment, waveguide matching part 207B is fitted into waveguide wall 201a together with a plurality of cantilever supports 207c. Then, as illustrated in FIG. 8, hole 208 is formed through waveguide wall 201a for inserting thereinto a portion of waveguide matching part 207B, comprised of the plurality of cantilever supports 207c. Hole 208 is a tapered circular hole, the diameter of which is increasingly reduced toward the inside of waveguide 201. The outer surface of the portion of waveguide matching part 207B, comprised of the plurality of cantilever supports 207c, is also tapered, with its outer diameter being increasingly reduced toward the leading end 207d of part 207B (the opening into which coaxial inner conductor 205 is inserted). The angle of the tapered outer surface is designed to be smaller than the angle of tapered hole 208 formed through waveguide wall 201a.

Further, waveguide matching part 207B has outer diameter E at the leading end thereof which is smaller than diameter F of hole 208 open to the outer surface of waveguide wall 201a, and larger than diameter J of hole 208 open to the inner surface of waveguide wall 201a. In addition, diameter F outside of waveguide wall 201a in hole 208 is designed to be slightly larger than the outer diameter of waveguide matching part 207B at proximal ends of the plurality of cantilever supports 207c.

Also, fitting hole 207a of waveguide matching part 207B has diameter G which is designed to be larger than diameter H of coaxial inner conductor 205.

By designing waveguide matching part 207B in the foregoing shape, coaxial inner conductor 205 goes into fitting hole 207a of waveguide matching part 207B as waveguide matching part 207B is inserted into hole 208 through waveguide wall 201a. In this process, the leading end 207d of waveguide matching part 207B hits against the side surface of tapered hole 208, causing each cantilever support 207c to deform toward the center line of fitting hole 207a in conformity to the increasingly reduced diameter of tapered hole 208. In other words, respective cantilever supports 207c are urged together inward in the radial direction of waveguide matching part 207B to gradually reduce the diameter of fitting hole 207a. Subsequently, when waveguide matching part 207B has been completely inserted into hole 208 of waveguide wall 201a as illustrated in FIG. 7, each cantilever support 207c is firmly in close contact with coaxial inner conductor 205.

As described above, waveguide matching part 207B does not have the requirement that the cantilever supports 207c be previously bent, as compared with the conventional counterpart. In addition, simply by inserting waveguide matching part 207B into tapered hole 208 formed through waveguide wall 201a and fixing waveguide matching part 207B in tapered hole 208, close contact is firmly maintained between waveguide matching part 207B and coaxial inner conductor 205. As a result, the heat conduction property is improved over the related art when heat generated in the helix of the traveling-wave tube is dissipated from coaxial inner conductor 205 to waveguide 201 through waveguide matching part 207B. In addition, waveguide matching part 207B improves the effect of preventing the temperature from rising in the coaxial section and helix, thus allowing stable operations without causing degraded electric characteristics.

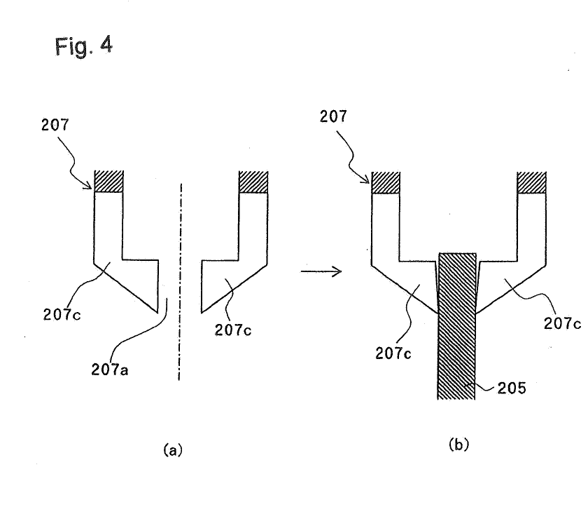

In this exemplary embodiment, the outer surface of waveguide matching part 207B is tapered in the portion comprised of a plurality of cantilever supports 207c for the following reason. The tapered outer surface prevents inclination of the wall surfaces of cantilever supports 207c which define fitting hole 207a, when waveguide matching part 207B is inserted into hole 208 of waveguide wall 201a. Accordingly, cantilever supports 207c are brought into plane contact with coaxial inner conductor 205. In contrast, when the outer surface of waveguide matching part 207B has the same outer diameter in the portion comprised of the plurality of cantilever supports 207c, cantilever supports 207c can be brought into point contact with coaxial inner conductor 205, as illustrated in FIG. 4(b), when such a waveguide matching part is inserted into hole 208 of waveguide wall 201a. In this event, however, a plane contact can be achieved, as described above, by tapering fitting hole 207a with its diameter being increasingly reduced toward the direction opposite to the opening into which coaxial inner conductor 205 is inserted.

In any case, each part is preferably designed to prevent cantilever supports 207c from coming into point contact with coaxial inner conductor 205. This is because, by designing waveguide matching part 207B in such a way, resulting waveguide matching part 207B further improves the heat dissipation property from coaxial inner conductor 205 to waveguide 201.

As described above, the present invention can improve contact between the coaxial inner conductor and waveguide matching part over the conventional structure. As a result, the present invention can increase the heat dissipation effect from the coaxial inner conductor to stabilize the operation, as compared with the conventional traveling-wave tube.

While exemplary embodiments of the present invention have been described using specific terms, such description is for illustrative purposes only, and it is to be understood that changes and variations may be made without departing from the spirit or scope of the following claims.

What is claimed is:

1. A coaxial waveguide converter circuit for converting an input/output coaxial section of a traveling-wave tube to a waveguide, comprising:
a waveguide matching part for connecting an inner conductor of said coaxial section extending into said waveguide to a wall of said waveguide,
wherein said waveguide matching part includes a fitting hole for fitting said inner conductor thereinto, and a plurality of cantilever supports at a leading end portion thereof, said cantilever supports defining said fitting hole, and
said plurality of cantilever supports defining said fitting hole include leading end portions which are uniformly in close contact with a peripheral surface of said inner conductor.

2. The coaxial waveguide converter circuit for a traveling-wave tube according to claim 1, wherein:
said plurality of cantilever supports are resilient,
said inner conductor includes a tapered leading end portion,
said fitting hole includes an opening for inserting said inner conductor therethrough, said opening having a diameter larger than the diameter of said inner conductor at an extreme leading end thereof, and smaller than the outer diameter of a body of said inner conductor except for the leading end, and
with said inner conductor being inserted into said fitting hole, said each cantilever support displaces outward in a radial direction of said waveguide matching part in conformity to the outer diameter of the body of said inner conductor, and each cantilever support, aided by its resiliency, simultaneously remains in contact with said inner conductor.

3. The coaxial waveguide converter circuit for a traveling-wave tube according to claim 1, wherein:
said waveguide includes a hole formed through the wall thereof for fitting thereinto a portion of said waveguide matching part comprised of said plurality of cantilever supports to fix said portion therein, said hole being tapered with a diameter thereof being increasingly reduced from the outside to the inside of said waveguide, and
said waveguide matching part is inserted into said hole, causing said each cantilever support to displace inward in the radial direction of said waveguide matching part to come into close contact with said inner conductor.

4. A waveguide matching part for use in a coaxial waveguide converter circuit for converting an input/output coaxial section of a traveling-wave tube to a waveguide, to connect an inner conductor of said coaxial section extending into said waveguide to a wall of said waveguide, said waveguide matching part comprising:
a fitting hole for fitting said inner conductor thereinto; and
a plurality of resilient cantilever supports at a leading end portion thereof, said cantilever supports defining said fitting hole,
wherein said fitting hole is tapered with a diameter thereof being increasingly reduced toward an opening of said fitting hole into which said inner conductor is inserted, and said insertion opening has a diameter smaller than the outer diameter of said inner conductor.

5. The waveguide matching part according to claim 4, wherein said fitting hole includes an opening opposite to said inner conductor insertion opening, said opening having the same diameter as the outer diameter of said inner conductor.

6. A method of manufacturing a coaxial waveguide converter circuit for converting an input/output coaxial section of a traveling-wave tube to a waveguide, said method comprising:
providing a waveguide matching part for connecting said inner conductor to a wall of said waveguide, said part comprising a fitting hole for fitting said inner conductor thereinto, and a plurality of cantilever supports which define said fitting hole at leading end portions thereof, and
subsequently inserting said inner conductor into said fitting hole of said waveguide matching part, while fixing said waveguide matching part on the wall of said waveguide, causing said each cantilever support to uniformly displace so as to come into close contact with a peripheral surface of said inner conductor.

7. The method of manufacturing a coaxial waveguide converter circuit according to claim 6, comprising:
tapering only a leading end portion of an inner conductor of said coaxial section extending into said waveguide;
providing said waveguide matching part, wherein said plurality of cantilever supports are resilient, said fitting hole includes an opening for inserting said inner conductor therethrough, and said opening has a diameter larger than the diameter of said inner conductor at an extreme leading end thereof, and smaller than the outer diameter of a body of said inner conductor except for the leading end; and
subsequently inserting said inner conductor into said fitting hole of said waveguide matching part, while fixing said waveguide matching part on the wall of said waveguide, causing said each cantilever support to displace outward in a radial direction of said waveguide matching part in conformity to the outer diameter of the body of said inner conductor to simultaneously come into contact with said inner conductor with the help of its resiliency.

8. The method of manufacturing a coaxial waveguide converter circuit according to claim 7, wherein providing said waveguide matching part includes tapering said fitting hole by increasingly reducing a diameter thereof toward an opening of said fitting hole into which said inner conductor is inserted.

9. The method of manufacturing a coaxial waveguide converter circuit according to claim 8, wherein said fitting hole includes an opening opposite to said inner conductor insertion opening, said opening having the same diameter as the outer diameter of said inner conductor.

10. The method of manufacturing a coaxial waveguide converter circuit according to claim 6, further comprising:
previously forming said waveguide with a tapered hole through the wall of sad waveguide by increasingly reducing the diameter of said tapered hole from the outside to the inside of said waveguide; and
fitting a portion of said waveguide matching part comprised of said plurality of cantilever supports into said tapered hole from the outside of said waveguide, causing said each cantilever support to displace inward in a radial direction of said waveguide matching part to come into close contact with said inner conductor.
